(19) United States
(12) Patent Application Publication
(10) Pub. No.: US 2025/0044545 A1
(43) Pub. Date: Feb. 6, 2025

(54) DRIVING MECHANISM

(71) Applicant: TDK TAIWAN CORP., Taoyuan City (TW)

(72) Inventors: Chao-Chang HU, Taoyuan City (TW); Ying-Jen WANG, Taoyuan City (TW)

(21) Appl. No.: 18/792,956

(22) Filed: Aug. 2, 2024

Related U.S. Application Data
(60) Provisional application No. 63/517,770, filed on Aug. 4, 2023.

(51) Int. Cl. G02B 7/08; G02B 27/64

(52) U.S. Cl. CPC G02B 7/08; G02B 27/646

(57) ABSTRACT

A driving mechanism for moving an optical element is provided. The driving mechanism includes a fixed part, a movable part, and a driving assembly. The movable part is movably connected to the fixed part for holding the optical element. The driving assembly is configured for moving the optical element relative to the fixed part.

### CROSS REFERENCE TO RELATED APPLICATIONS

This application claims the benefit of U.S. provisional application No. 63/517,770, filed Aug. 4, 2023, the entirety of which is incorporated by reference herein.

### BACKGROUND OF THE INVENTION

### Field of the Invention

The present invention relates to a driving mechanism, and, in particular, it relates to a driving mechanism for moving an optical element.

### Description of the Related Art

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

Electronic devices usually use several coils and magnets for adjusting the focus of a lens. However, miniaturization of these electronic devices may increase the difficulty of mechanical design, and it may also lead to low reliability and a low positioning accuracy of the driving mechanism. It has been a challenge to address this problem.

### BRIEF SUMMARY OF THE INVENTION

An embodiment of the present invention provides a driving mechanism for moving an optical element. The driving mechanism includes a fixed part, a movable part, and a driving assembly. The movable part is movably connected to the fixed part for holding the optical element. The driving assembly is configured for moving the optical element relative to the fixed part.

In some embodiments, the driving mechanism further includes a substrate, wherein the fixed part includes a shield, and the movable part includes a resilient circuit board, wherein at least a part of the circuit board is located between the substrate and the shield.

In some embodiments, the substrate forms a recess, and the circuit board has a conductive terminal portion received in the recess.

In some embodiments, when viewed along a horizontal direction that is perpendicular to the optical axis of the optical lens, the conductive terminal portion and the substrate at least partially overlap.

In some embodiments, the lower surface of the conductive terminal portion is aligned with the bottom surface of the substrate.

In some embodiments, the optical element includes an image sensor.

In some embodiments, the circuit board is covered by the substrate.

In some embodiments, the circuit board is electrically connected to the substrate.

In some embodiments, the hardness of the substrate is greater than the hardness of the circuit board.

In some embodiments, the driving mechanism further includes a first module, a second module, and a third module connected to each other, wherein the first module has the shield, the circuit board, the driving assembly, a first housing connected to the shield and a first optical lens disposed in the first housing, the second module has a second housing and a second optical lens disposed in the second housing, and the third module has the substrate, a third housing and a third optical lens disposed on the third housing, wherein the substrate is affixed to the bottom of the third housing.

In some embodiments, the second module is located between the first and third modules, the first and third optical lenses are prisms, the second optical lens includes a transparent lens, and the optical element includes an image sensor.

In some embodiments, the first module further has a first frame and a second frame disposed on the circuit board, the second frame is located between the first frame and the shield, and the driving assembly includes a first coil disposed on the first frame and a first magnet disposed on the second frame.

In some embodiments, the driving assembly further includes a second coil disposed on the second frame and a second magnet disposed on the shield.

In some embodiments, the shield, the first frame, and the second frame respectively have a C-shaped structure facing the same direction.

In some embodiments, the first coil surrounds the optical axis of the optical element, and the optical axis extends through the first optical lens.

In some embodiments, the first module further has a first frame and a second frame disposed on the circuit board, the second frame is located between the shield and the first frame, and the driving assembly includes a first coil, a second coil and a common magnet, wherein the first coil is disposed on the first frame, the common magnet is disposed on the second frame, and the second coil is disposed on the lower surface of the first housing, wherein the first and second coils are located close to the common magnet.

In some embodiments, the first module further has a first frame and a second frame disposed on the circuit board, and the circuit board has a first connecting portion, a second connecting portion and a first resilient structure, wherein the first frame is disposed on the first connecting portion, the second frame is disposed on the second connecting portion, and the first resilient structure is connected between the first and second connecting portions.

In some embodiments, the circuit board further has a third connecting portion and a second resilient structure, and the second resilient structure is connected between the second and third connecting portions.

In some embodiments, the shield is affixed to the substrate.

In some embodiments, the circuit board has an extending portion that extends across the second module to the third module.

In some embodiments, the extending portion forms a through hole for receiving a part of the driving assembly.

In some embodiments, the extending portion has a C-shaped structure and is parallel to the optical axis of the optical element.

In some embodiments, the fixed part includes a shield, the movable part includes a resilient circuit board, and the driving mechanism further includes a first frame and a second frame disposed on the circuit board, wherein the driving assembly is disposed on the shield, the first frame and the second frame, and the second frame is located between the first frame and the shield.

### BRIEF DESCRIPTION OF THE DRAWINGS

The present invention can be more fully understood by reading the subsequent detailed description and examples with references made to the accompanying drawings, wherein:

FIG. 1 shows a perspective diagram of a driving mechanism 100 in accordance with an embodiment of the invention.

FIG. 2 shows another perspective diagram of a driving mechanism 100 in FIG. 1.

FIG. 3 shows an exploded view of the driving mechanism 100 in FIGS. 1 and 2.

FIG. 4 shows an exploded view of the first module 10 in FIG. 3.

FIG. 5 is a perspective diagram of the first module 10 when the first housing 11 and the first optical lens R are omitted.

FIG. 6 is another perspective diagram of the first module 10 when the first housing 11 and the first optical lens R are omitted.

FIG. 7 is a cross-sectional view taken along line A1-A2 in FIG. 2

FIG. 8 is a cross-sectional view along line A3-A4 in FIG. 2.

FIG. 9 shows a perspective diagram of a driving mechanism 200 in accordance with another embodiment of the invention.

FIG. 10 shows an exploded view of the driving mechanism 200 in FIG. 9.

FIG. 11 is a cross-sectional view of a driving mechanism in accordance with another embodiment of the invention.

FIG. 12 is partial enlarged perspective view of a driving mechanism in accordance with another embodiment of the invention.

FIGS. 13 and 14 are perspective diagrams of a driving mechanism 300 in accordance with another embodiment of the invention.

FIG. 15 shows an exploded view of the driving mechanism 300 in FIGS. 13 and 14.

FIG. 16 is an exploded diagram showing the first module 10 in FIGS. 13-15 with the first housing 11 and the first optical lens R omitted.

FIG. 17 is an exploded view of the optical element S and the circuit board Q before assembly.

FIG. 18 is a perspective diagram showing the extending portions QC of the circuit board Q that extend across the second module 20 to the third module 30 along the −Y direction.

FIG. 19 is a perspective diagram of a driving mechanism 400 in accordance with another embodiment of the invention.

FIG. 20 is an exploded view of the driving mechanism 400 in FIG. 19 before assembly.

### DETAILED DESCRIPTION OF THE INVENTION

The making and using of the embodiments of the driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

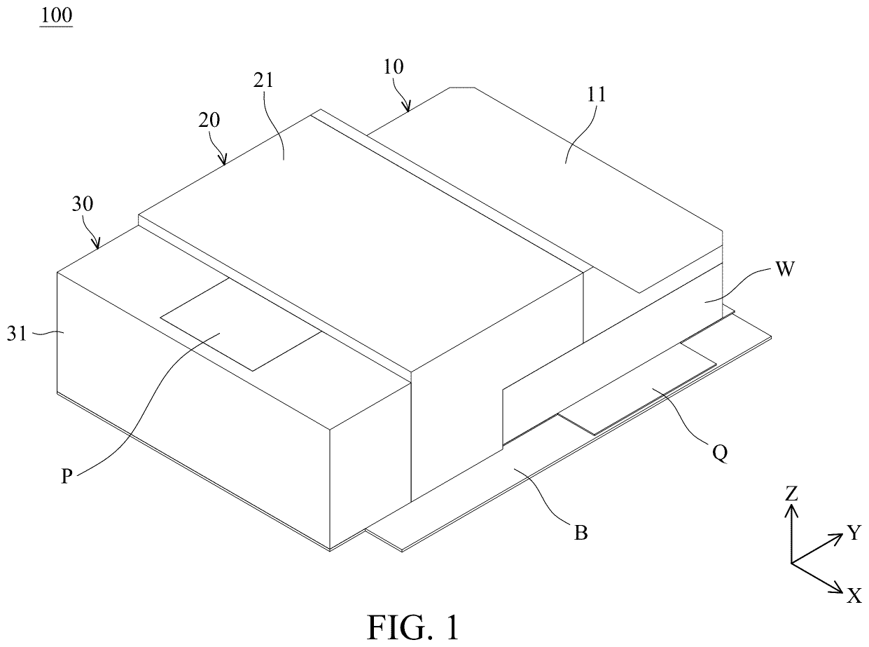

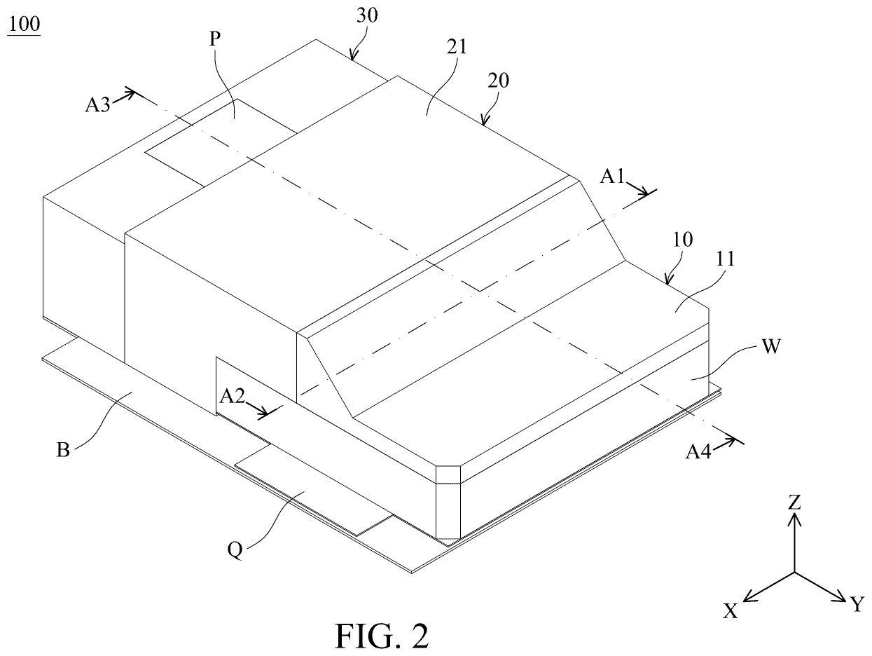

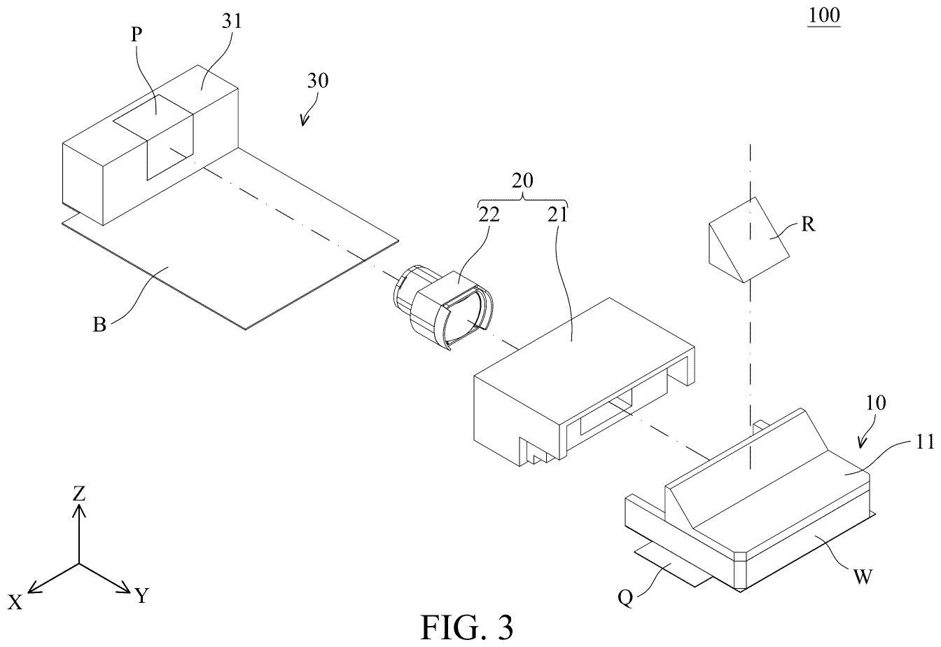

FIG. 1 shows a perspective diagram of a driving mechanism 100 in accordance with an embodiment of the invention. FIG. 2 shows another perspective diagram of a driving mechanism 100 in FIG. 1. FIG. 3 shows an exploded view of the driving mechanism 100 in FIGS. 1 and 2.

Referring to FIGS. 1-3, the driving mechanism 100 in this embodiment is a Voice Coil Motor (VCM) which may be disposed in a cell phone or other portable electronic device for driving an optical element (e.g. transparent lens, prism, or image sensor) to move, thereby achieving the function of Auto-Focusing (AF) or Optical Image Stabilization (OIS).

The driving mechanism 100 primarily comprises a first module 10, a second module 20, and a third module 30 connected to each other. The first module 10 has a first housing 11, a shield W, a first optical lens R (e.g. prism), and a resilient circuit board Q. The first optical lens R is disposed in the first housing 11. The shield W is connected between the first housing 11 and the circuit board Q.

The second module 20 is disposed between the first and third modules 10 and 30, including a second housing 21 and a second optical lens 22 (e.g. transparent lens) affixed to the second housing 21. Moreover, the third module 30 includes a third housing 31, a third optical lens P (e.g. prism), and a substrate B (e.g. printed circuit board). The third optical lens P is disposed on the top side of the third housing 31, and the substrate B is affixed to the bottom side of the third housing 31 for covering and sustaining the circuit board Q, wherein the hardness of the substrate B is greater than the hardness of the circuit board Q.

After assembly of the driving mechanism 100, as shown in FIGS. 1 and 2, at least a part of the circuit board Q is connected between the shield W and the substrate B. In this embodiment, as the circuit board Q can be electrically connected to and integrated with the substrate B, circuit design of the driving mechanism 100 can be simplified, and miniaturization of the driving mechanism 100 can be also achieved.

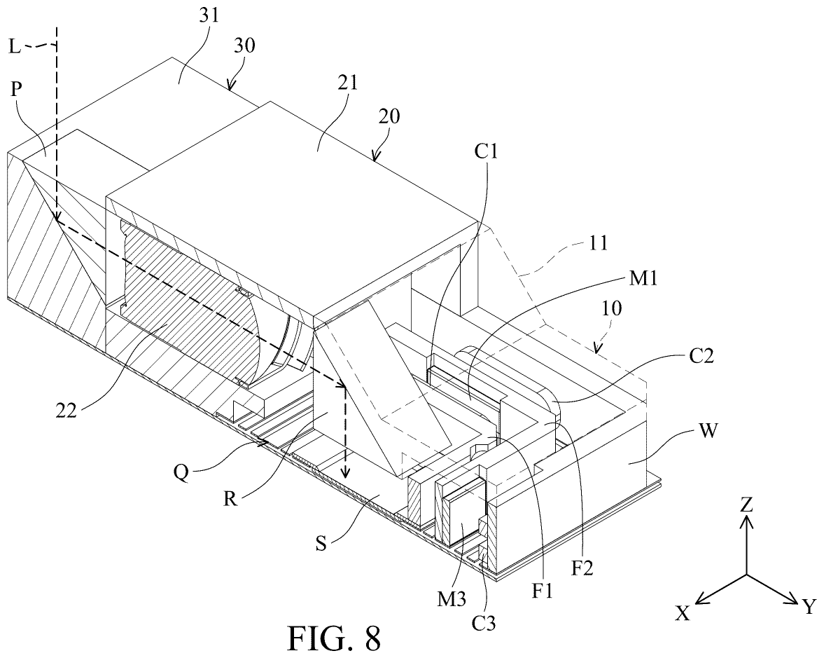

It can be seen in FIG. 8 that the external light L enters the third optical lens P in the −Z direction. The external light L is then reflected by the third optical lens P and propagates through the second optical lens 22 along the Y direction to the first optical lens R. Subsequently, the external light L is reflected by the first optical lens R and reaches the optical element S (e.g. image sensor) on the main body QB of the circuit board Q along the −Z direction, thereby forming a digital image.

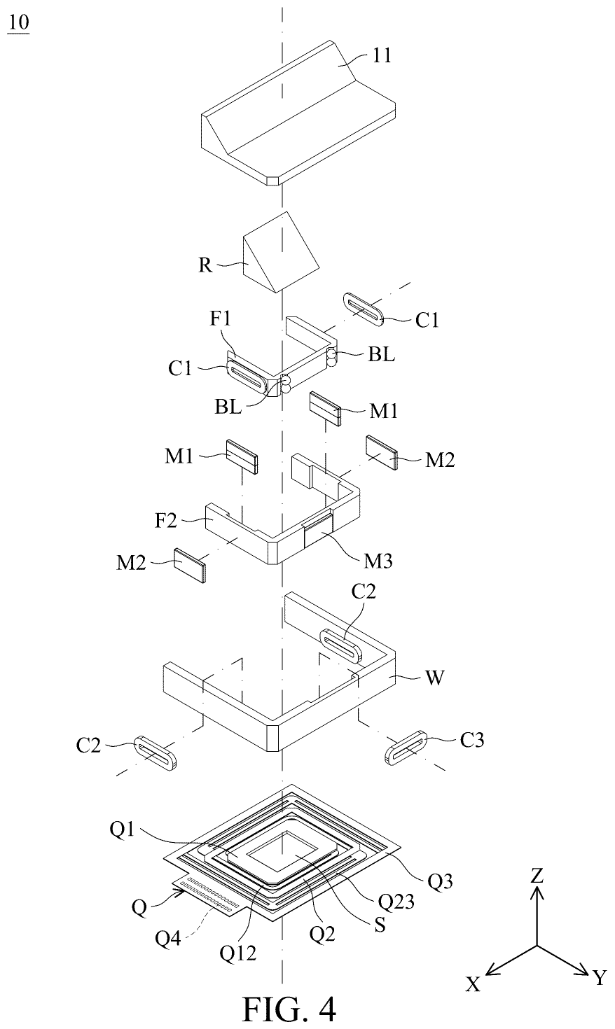

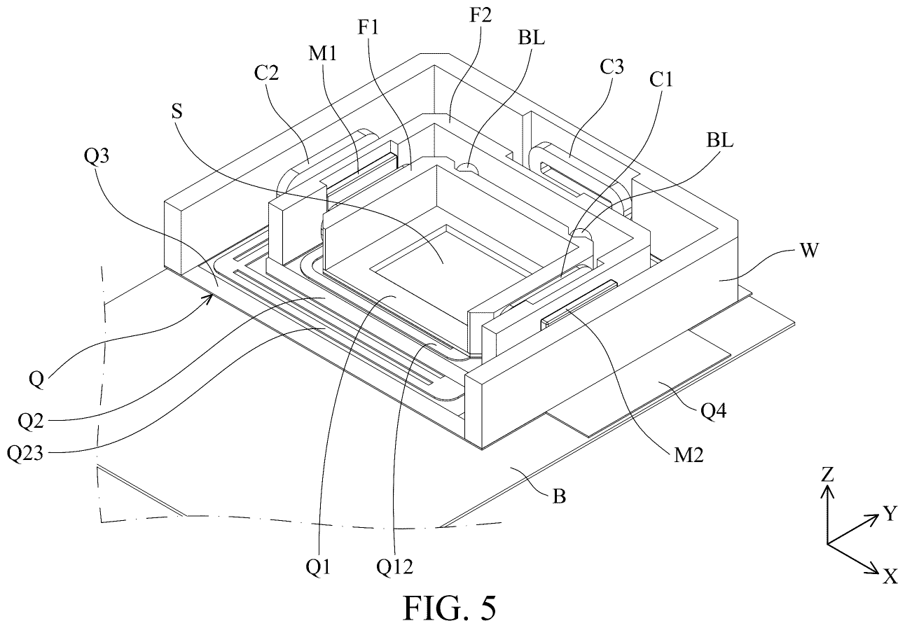

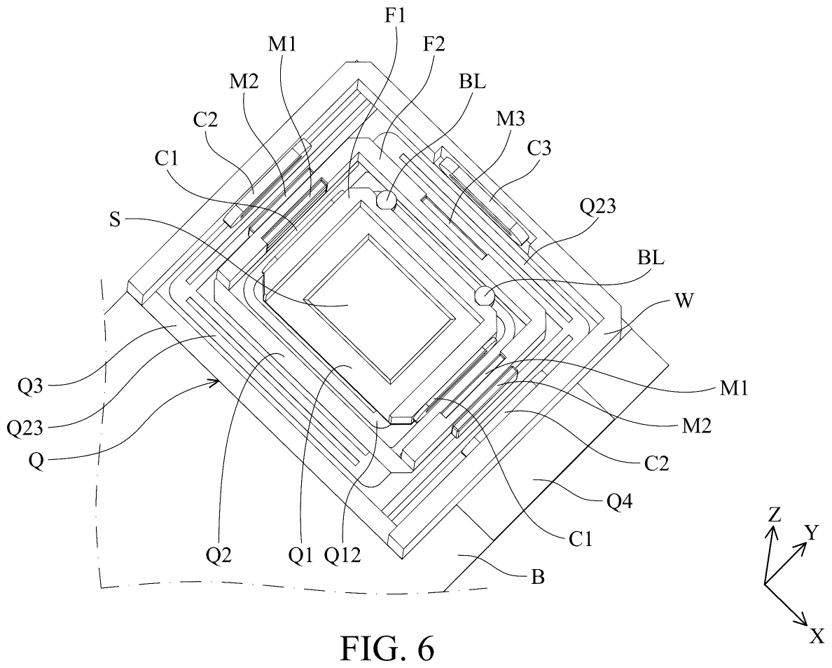

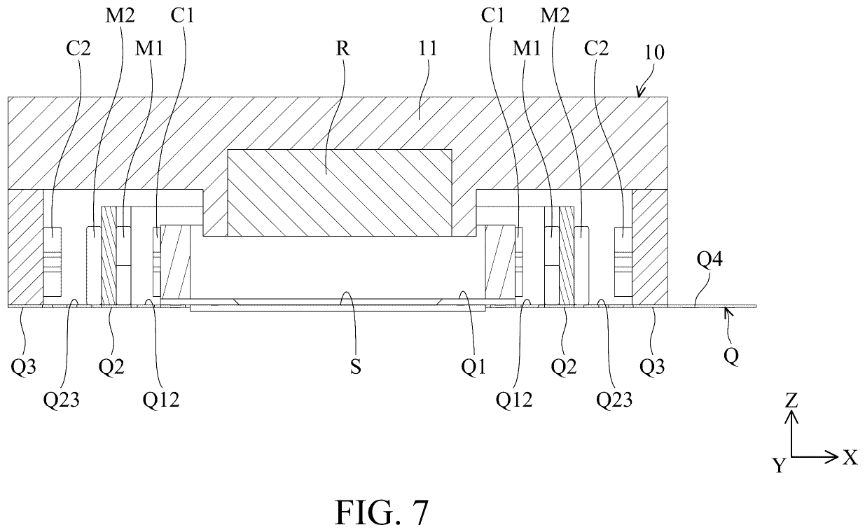

FIG. 4 shows an exploded view of the first module 10 in FIG. 3. FIG. 5 is a perspective diagram of the first module 10 when the first housing 11 and the first optical lens R are omitted. FIG. 6 is another perspective diagram of the first module 10 when the first housing 11 and the first optical lens R are omitted. FIG. 7 is a cross-sectional view taken along line A1-A2 in FIG. 2. It can be seen in FIGS. 5-6 that the circuit board Q of the first module 10 and the substrate B of the third module 30 are connected to each other.

Referring to FIGS. 4-7, the resilient circuit board Q constitutes a movable part of the driving mechanism 100, and it includes a first connecting portion Q1, a second connecting portion Q2, a third connecting portion Q3, a conductive terminal portion Q4, a first resilient structure Q12, and a second resilient structure Q23.

The thin and meandering first resilient structure Q12 is connected between the first and second connecting portions Q1 and Q2, and the thin and meandering second resilient structure Q23 is connected between the second and third connecting portions Q2 and Q3. Moreover, the conductive terminal portion Q4 protrudes from a side of the third connecting portion Q3 in the X direction. In this embodiment, the coils and the optical element S (image sensor) in the first module 10 may be electrically connected to the circuit board Q via conductive wires, and they can be further electrically connected to the external circuit through the conductive terminal portion Q4 of the circuit board Q.

The shield W of the first module 10 constitutes a fixed part of the driving mechanism 100. A first frame F1 and a second frame F2 are disposed in the shield W. Here, all of the shield W and the first and second frames F1 and F2 have a C-shaped structure with an opening facing the −Y direction. The first frame F1 is affixed to the first connecting portion Q1, the second frame F2 is affixed to the second connecting portion Q2, and the shield W is affixed to the third connecting portion Q3.

As shown in FIGS. 4-7, two first coils C1 are disposed on the outer surface of the first frame F1. Two first magnets M1 are disposed on the inner surface of the second frame F2 and positioned corresponding to the first coils C1. The second frame F2 is situated between the first frame F1 and the shield W, and the optical element S (e.g. image sensor) is disposed at the center of the first connecting portion Q1 of the circuit board Q.

Two second magnets M2 and a third magnet M3 are disposed on the outer surface of the second frame F2. Two second coils C2 and a third coil C3 are disposed on the inner surface of the shield W. The second coils C2 are positioned corresponding to the second magnets M2, and the third coil C3 is positioned corresponding to the third magnets M3.

It should be noted that the first connecting portion Q1, the second connecting portion Q2, the first resilient structure Q12, the second resilient structure Q23, and the optical element S at the center of the circuit board Q are spaced apart from the substrate B along the Z axis. The third connecting portion Q3 and the conductive terminal portion Q4 are affixed to the substrate B by adhesion or soldering/welding.

The first, second, third magnets M1-M3 and the first, second, third coils C1-C3 constitute a driving assembly of the driving mechanism 100 for moving the optical sensor S. When a current is applied to the first coils C1, the first coils C1 and the first magnets M1 can generate an electromagnetic force parallel to the Z direction and the optical axis O. Hence, the first frame F1 and the optical sensor S at the center of the first connecting portion Q1 can be driven to move relative to the second frame F2 along the Z axis, thereby achieving the function of Auto-Focusing (AF) and/or Optical Image Stabilization (OIS) along the Z axis.

Additionally, when a current is applied to the second coils C2, the second coils C2 and the second magnets M2 can generate an electromagnetic force in a horizontal direction that is parallel to the X axis. Hence, the second connecting portion Q2 and the second frame F2 can be driven to move relative to the shield W along the X axis, thereby achieving the function of Optical Image Stabilization (OIS) of the driving mechanism 100 along the X axis.

Similarly, when a current is applied to the third coil C3, the third coil C3 and the third magnet M3 can generate an electromagnetic force in a horizontal direction that is parallel to the Y axis. Hence, the second connecting portion Q2 and the second frame F2 can be driven to move relative to the shield W along the Y axis, thereby achieving the function of Optical Image Stabilization (OIS) of the driving mechanism 100 along the Y axis.

In this embodiment, a plurality of rollers BL are disposed between the first and second frames F1 and F2, whereby the first frame F1 can smoothly slide relative to the second frame F2 along the Z axis and the optical axis O of the optical sensor S, whereby the reliability of the driving mechanism 100 can be improved.

FIG. 8 is a cross-sectional view along line A3-A4 in FIG. 2. Referring to FIG. 8, the external light L enters the third optical lens P in the −Z direction. The external light L is then reflected by the third optical lens P and propagates through the second optical lens 22 to the first optical lens R. Subsequently, the external light L is reflected by the first optical lens R and reaches to the optical sensor S at the center of the circuit board Q along the −Z direction, thereby forming a digital image.

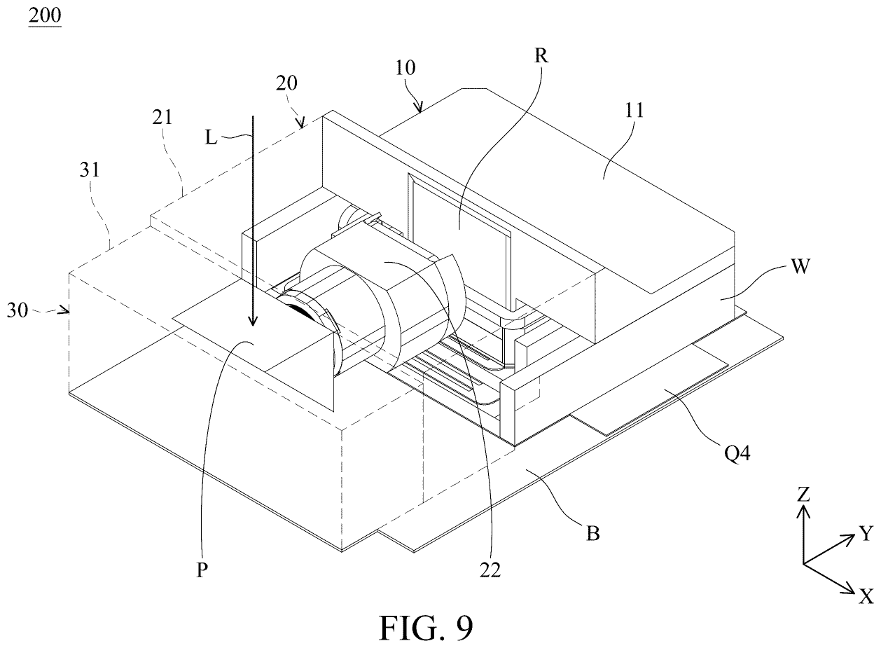

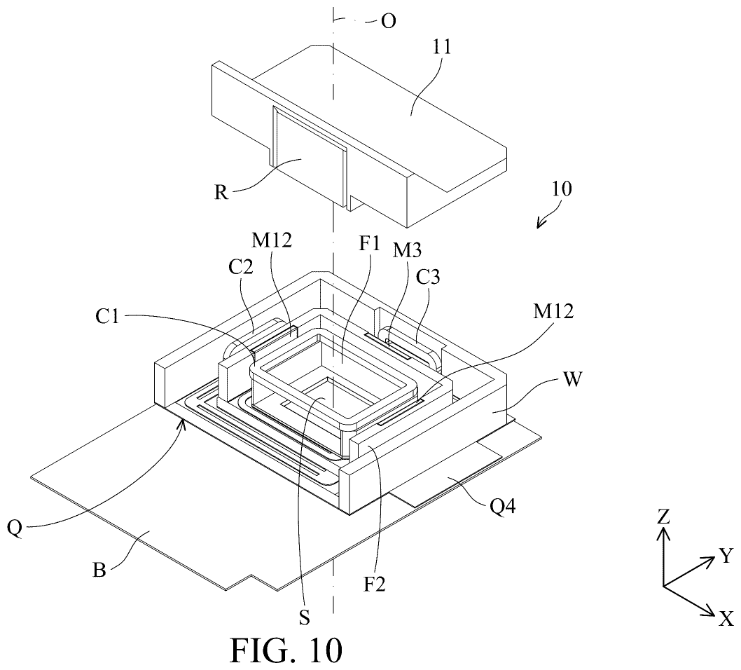

FIG. 9 shows a perspective diagram of a driving mechanism 200 in accordance with another embodiment of the invention. FIG. 10 shows an exploded view of the driving mechanism 200 in FIG. 9.

Referring to FIGS. 9-10, the driving mechanism 200 is different from the driving mechanism 100 of FIGS. 1-8 in that a first coil C1 is disposed on the top side of the first frame F1 and surrounds the optical axis O of the optical sensor S (e.g. image sensor) at the center of the circuit board Q, wherein the optical axis O of the optical sensor S extends through the first optical lens R.

In this embodiment, the first and second magnets M1 and M2 in FIGS. 1-8 are replaced by the common magnets M12 (FIG. 10). The first coil C1 and the common magnets M12 can generate an electromagnetic force parallel to the Z direction, and the second coil C2 and the common magnets M12 can generate an electromagnetic force parallel to the X direction. Thus, the functions of Auto-Focusing (AF) and Optical Image Stabilization (OIS) can be achieved, and the size of the driving mechanism 200 along the X axis can also be reduced to achieve miniaturization of the electronic device.

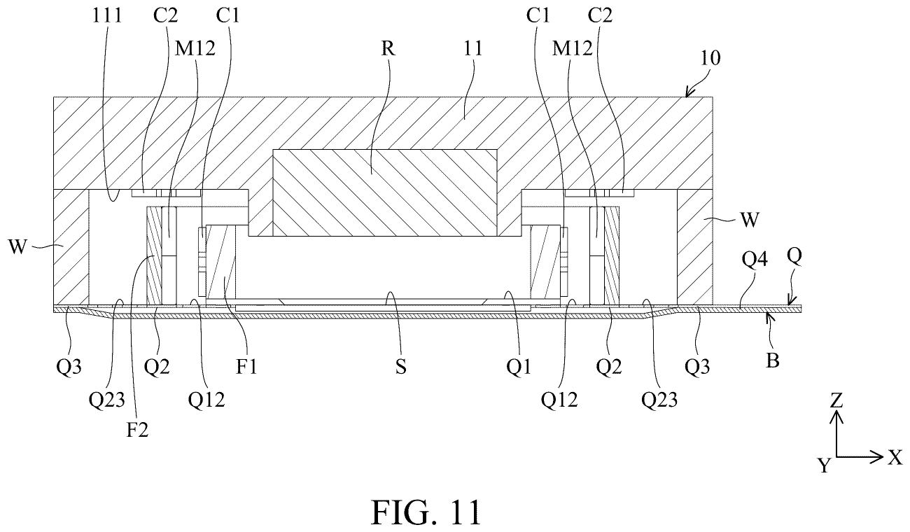

FIG. 11 is a cross-sectional view of a driving mechanism in accordance with another embodiment of the invention. The first and second magnets M1 and M2 in FIGS. 1-8 are replaced by the common magnets M12 in FIG. 11. Moreover, the second coils C2 are disposed on the lower surface 111 of the first housing 11 and positioned adjacent to the common magnet M12.

It can be seen in FIG. 11 that the first connecting portion Q1, the second connecting portion Q2, the first resilient structure Q12, the second resilient structure Q23, and the optical sensor S at the center of the circuit board Q are spaced apart from the substrate B along the Z axis. Additionally, the third connecting portion Q3 and the conductive terminal portion Q4 are affixed to the substrate B by adhesion or soldering/welding.

With the configuration of the driving mechanism in FIG. 11, the first coils C1 and the common magnets M12 can generate an electromagnetic force parallel to the Z direction, and the second coil C2 and the common magnets M12 can generate an electromagnetic force perpendicular to the Z direction. Thus, the functions of Auto-Focusing (AF) and Optical Image Stabilization (OIS) can be achieved, and the size of the driving mechanism 200 along the X axis can also be reduced to achieve miniaturization of the electronic device.

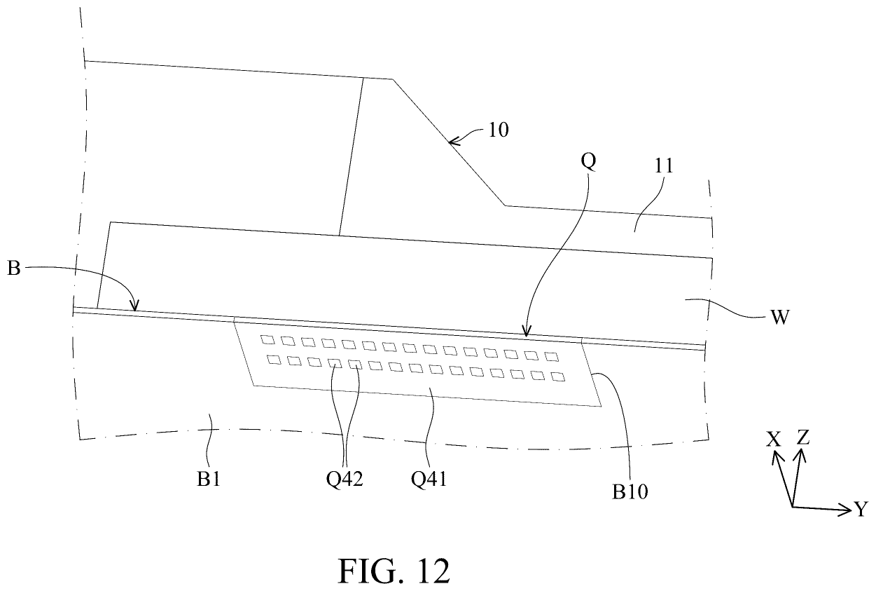

FIG. 12 is partial enlarged perspective view of a driving mechanism in accordance with another embodiment of the invention. To reduce the thickness of the driving mechanism in the Z direction, as shown in FIG. 12, the substrate B forms a recess B10, wherein the conductive terminal portion Q4 is bent relative to the third connecting portion Q3 and received in the recess B10 of the substrate B.

When viewed along the horizontal direction (X or Y direction), the conductive terminal portion Q4 and the substrate B at least partially overlap. In some embodiments, the lower surface Q41 of the conductive terminal portion Q4 is aligned with the bottom surface B1 of the substrate B. It can be seen in FIG. 12 that a plurality of conductive pads Q42 are disposed on the lower surface Q41 of the conductive terminal portion Q4. The conductive pads Q42 can be directly and electrically connected to the external circuit without passing the substrate B.

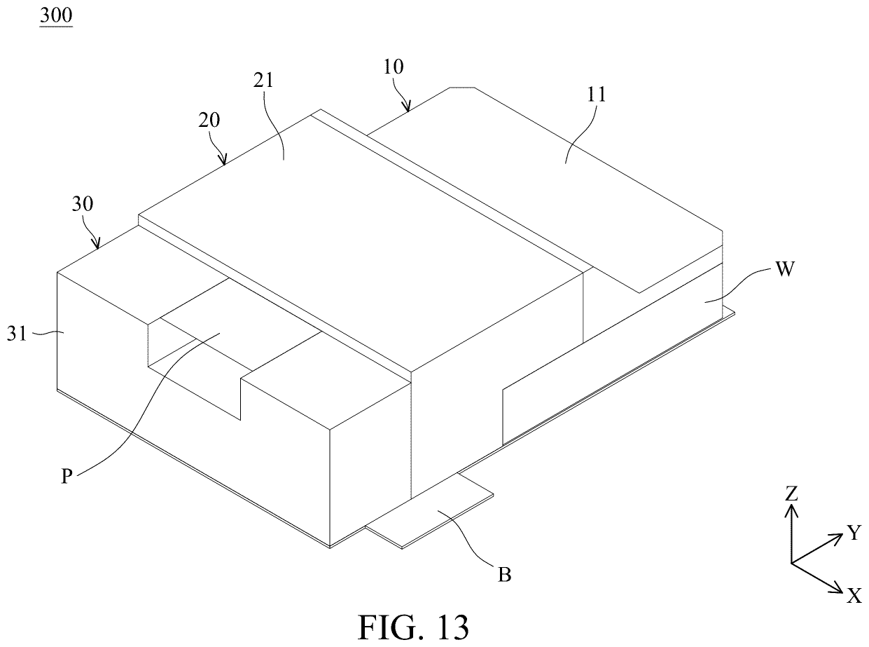

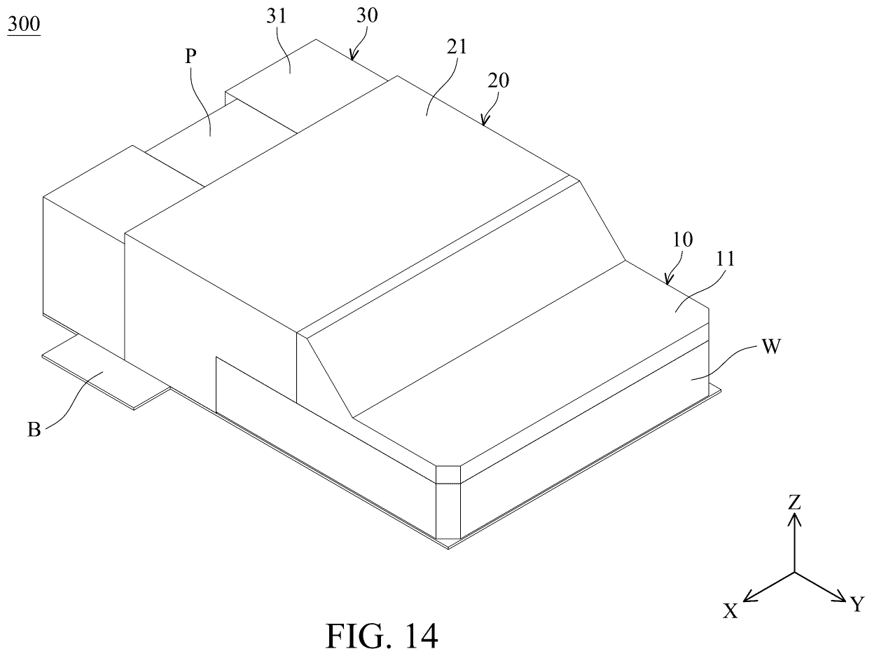

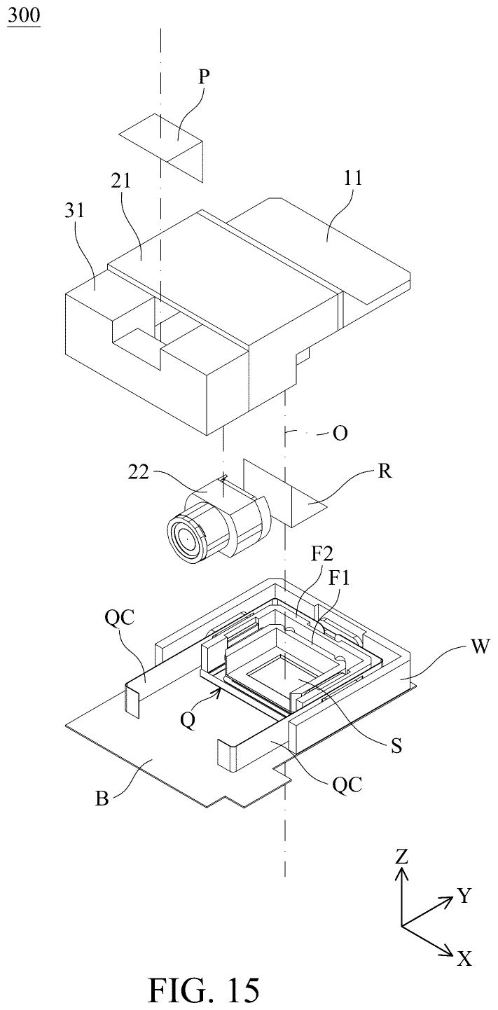

FIGS. 13 and 14 are perspective diagrams of a driving mechanism 300 in accordance with another embodiment of the invention. FIG. 15 shows an exploded view of the driving mechanism 300 in FIGS. 13 and 14.

Referring to FIGS. 13-15, the driving mechanism 300 in this embodiment is different from the driving mechanism 100 of FIGS. 1-8 in that the circuit board Q has two longitudinal extending portions QC, whereby the optical sensor S (e.g. image sensor) and the coils inside the first module 10 can be electrically connected to the circuit (not shown) in the third module 30.

Moreover, as shown in FIG. 15 the first, second and third housings 11, 21, and 31 of the first, second and third modules 10, 20 and 30 can be either assembled to each other or integrally formed in one piece, which is not limited by the embodiments of the present invention.

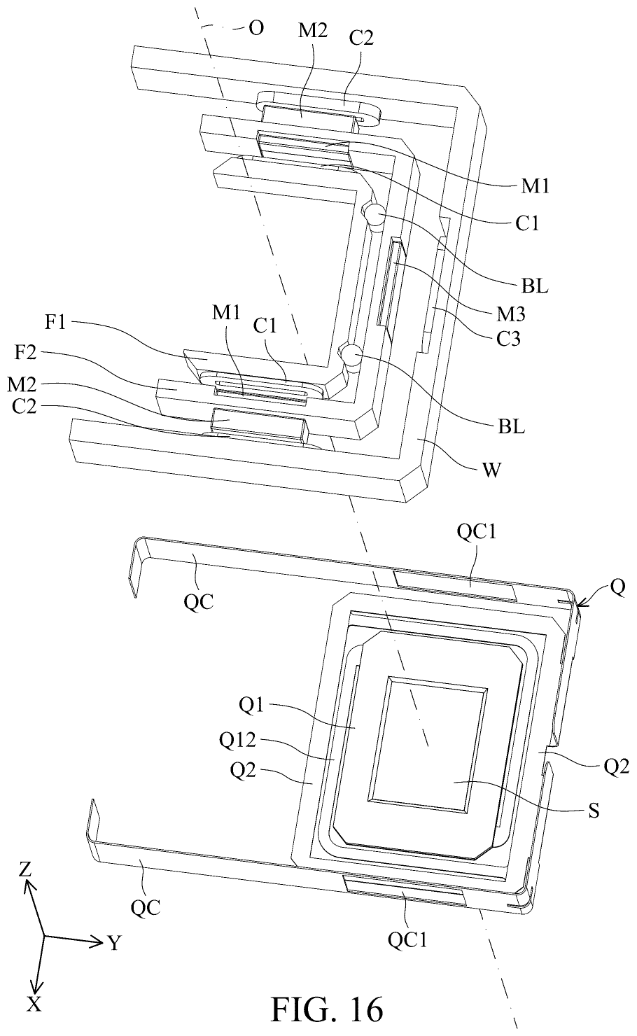

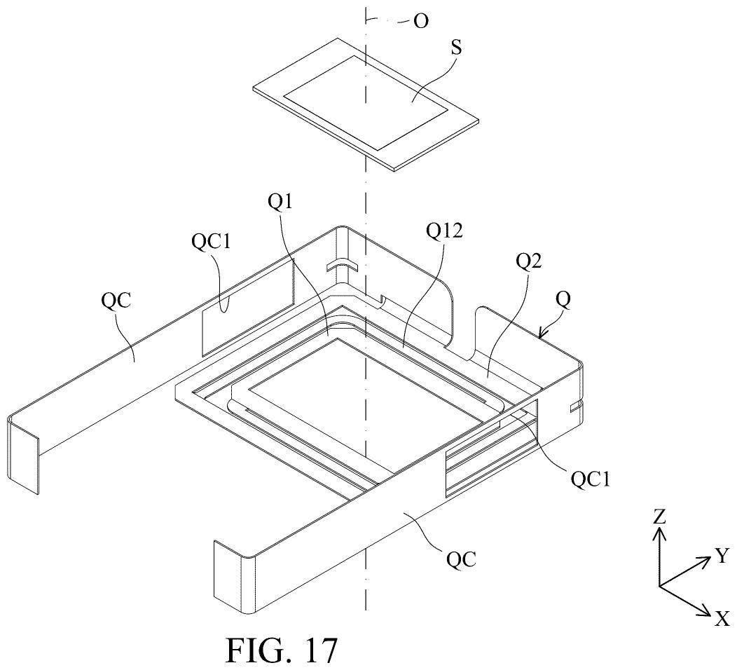

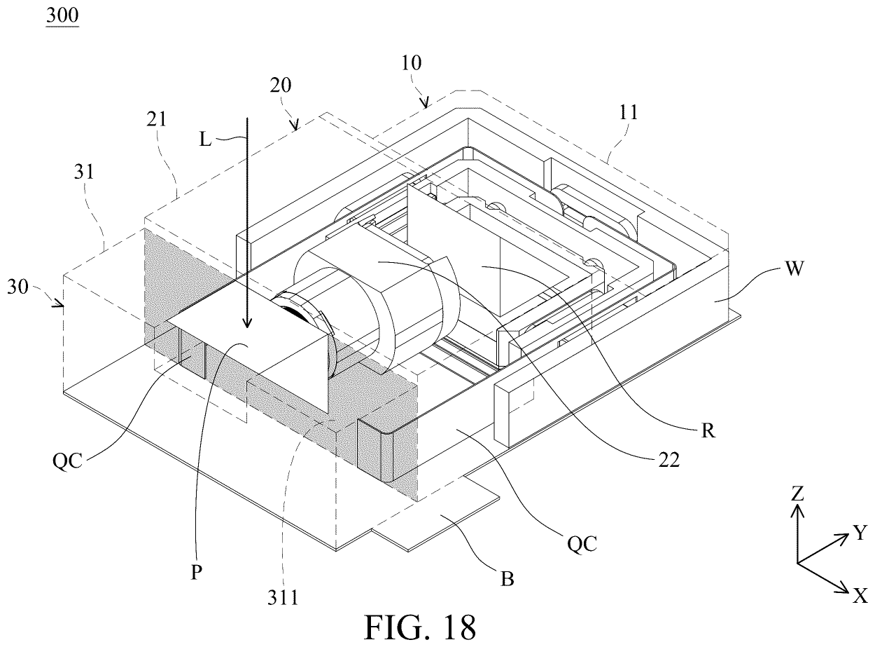

FIG. 16 is an exploded diagram showing the first module 10 in FIGS. 13-15 with the first housing 11 and the first optical lens R omitted. FIG. 17 is an exploded view of the optical element S and the circuit board Q before assembly. FIG. 18 is a perspective diagram showing the extending portions QC of the circuit board Q that extend across the second module 20 to the third module 30 along the −Y direction.

As shown in FIGS. 16 and 17, the circuit board Q includes a first connecting portion Q1, a second connecting portion Q2, a first resilient structure Q12, and two extending portions QC connected to the second connecting portion Q2. The thin and meandering first resilient structure Q12 is connected between the first and second connecting portions Q1 and Q2. The extending portions QC are bent relative to the second connecting portion Q2 and parallel to the optical axis O.

A first frame F1 and a second frame F2 are disposed inside the shield W of the first module 10. It should be noted that the shield W and the first and second frames F1 and F2 have a C-shaped structure with the opening facing the same direction (−Y direction). Here, the first frame F1 is affixed to the first connecting portion Q1, the second frame F2 is affixed to the second connecting portion Q2, and the shield W is affixed to the substrate B.

As shown in FIG. 16, two first coils C1 are disposed on the outer surface of the first frame F1. Two first magnets M1 are disposed on the inner surface of the second frame F2 and positioned corresponding to the first coils C1. The second frame F2 is situated between the first frame F1 and the shield W, and the optical element S (e.g. image sensor) is disposed at the center of the first connecting portion Q1 of the circuit board Q.

Two second magnets M2 and a third magnet M3 are disposed on the outer surface of the second frame F2. Two second coils C2 and a third coil C3 are disposed on the inner surface of the shield W. The second coils C2 are positioned corresponding to the second magnets M2, and the third coil C3 is positioned corresponding to the third magnets M3.

It should be noted that the C-shaped extending portions QC are formed by bending two parts of the circuit board Q relative to the second connecting portion Q2. Hence, the extending portions QC are parallel to the Z axis and located between the shield W and the second frame F2. Therefore, the optical sensor S and the coils inside the first module 10 can be electrically connected to the circuit in the third module 30 through the circuit board Q.

In this embodiment, each of the extending portions QC forms a through hole QC1 for receiving the second magnet M2, whereby the size of the driving mechanism 300 along the X axis can be reduced, and miniaturization of the electronic device can be achieved.

FIG. 18 shows that the external light L can enter the third optical lens P in the −Z direction. The external light L is then reflected by the third optical lens P and propagates through the second optical lens 22 to the first optical lens R. Subsequently, the external light L is reflected by the first optical lens R and reaches the optical sensor S at the center of the circuit board Q, thereby forming a digital image. With the extending portions QC that extend across the second module 20 to the third module 30, the optical sensor S and the coils inside the first module 10 can be electrically connected to the conductive pads (not shown) on the inner wall 311 of the third housing 31, whereby miniaturization of the driving mechanism 300 and the electronic device can be achieved.

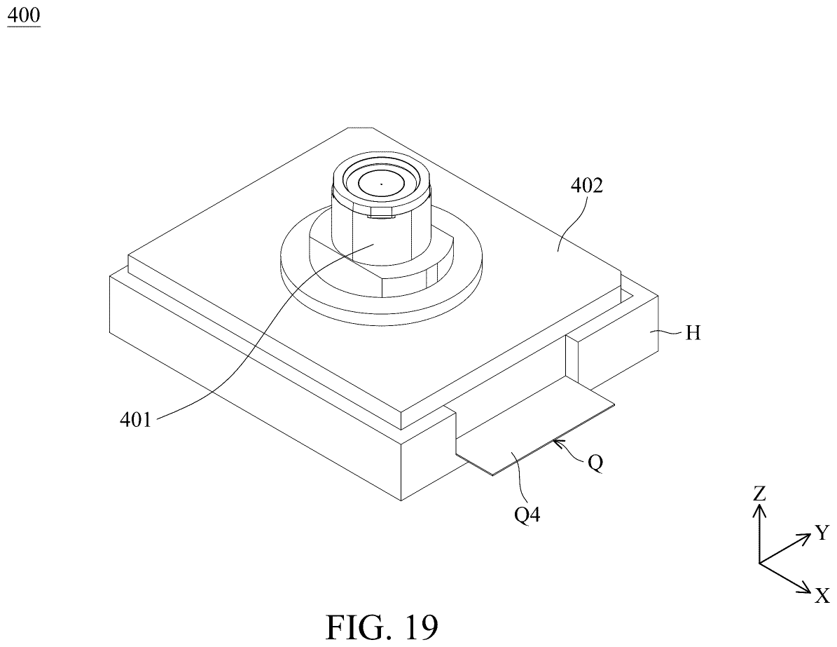

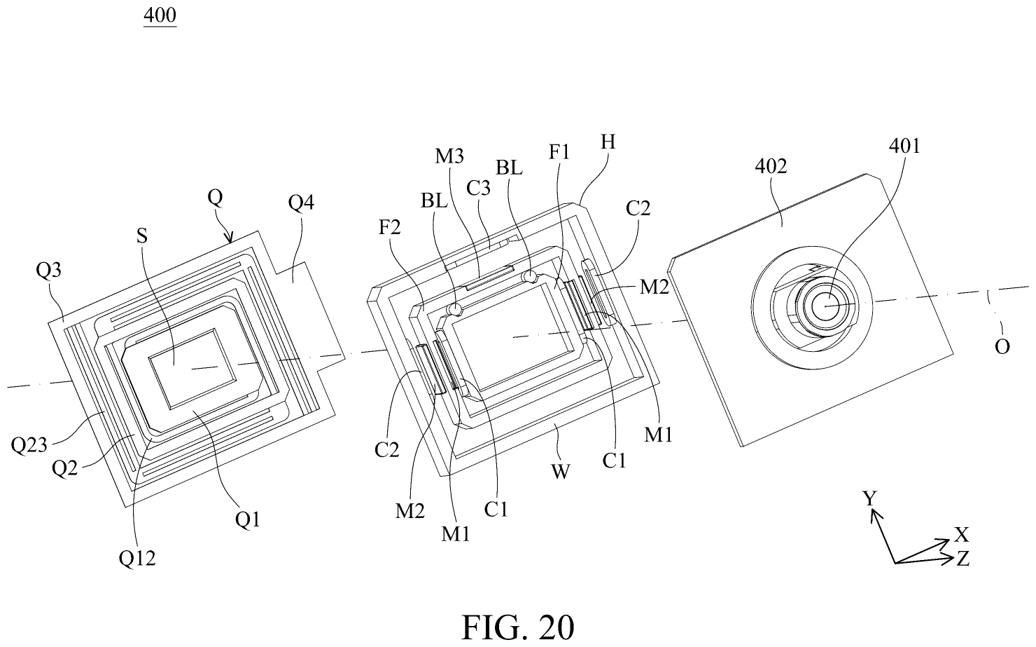

FIG. 19 is a perspective diagram of a driving mechanism 400 in accordance with another embodiment of the invention. FIG. 20 is an exploded view of the driving mechanism 400 in FIG. 19 before assembly.

As shown in FIGS. 19 and 20, another embodiment of the driving mechanism 400 primarily includes a first optical lens 401, a first housing 402, a shield H (fixed part), a circuit board Q (movable part), and an optical element S (e.g. image sensor).

The first optical lens 401 (e.g. transparent lens) is affixed at the center of the first housing 402. The shield H is connected between the first housing 402 and the circuit board Q. The optical element S is disposed at the center of the circuit board Q, and the optical axis O of the optical element S extends through the first optical lens 401.

It can be seen in FIGS. 19 and 20 that the circuit board Q comprises a first connecting portion Q1, a second connecting portion Q2, a third connecting portion Q3, a conductive terminal portion Q4, a first resilient structure Q12, and a second resilient structure Q23. The thin and meandering first resilient structure Q12 is connected between the first and second connecting portions Q1 and Q2, and the thin and meandering second resilient structure Q23 is connected between the second and third connecting portions Q2 and Q3.

Moreover, the conductive terminal portion Q4 protrudes from a side of the third connecting portion Q3 in the X direction. The coils and optical element S (e.g. image sensor) can be electrically connected to the external circuit through the conductive terminal portion Q4 of the circuit board Q.

Specifically, a first frame F1 and a second frame F2 are disposed inside the shield H of the first module 10. It should be noted that the shield H and the first and second frames F1 and F2 have a rectangular hollow structure. The first frame F1 is affixed to the first connecting portion Q1, the second frame F2 is affixed to the second connecting portion Q2, and the shield H is affixed to the third frame F3.

As shown in FIG. 20, two first coils C1 are disposed on the outer surface of the first frame F1. Two first magnets M1 are disposed on the inner surface of the second frame F2 and positioned corresponding to the first coils C1. The second frame F2 is situated between the first frame F1 and the shield H, and the optical element S (e.g. image sensor) is disposed at the center of the first connecting portion Q1 of the circuit board Q.

Moreover, two second magnets M2 and a third magnet M3 are disposed on the outer surface of the second frame F2. Two second coils C2 and a third coil C3 are disposed on the inner surface of the shield H. The second coils C2 are positioned corresponding to the second magnets M2, and the third coil C3 is positioned corresponding to the third magnet M3.

With the configuration of the driving mechanism 400, the coils and the magnets (driving assembly) in the driving mechanism 400 can generate an electromagnetic force to move the first frame F1 and the optical element S on the first connecting portion Q1 with respect to the second frame F2 along the optical axis O (Z axis), or to move the second connecting portion Q2 and the second frame F2 with respect to the shield H in a direction that is perpendicular to the optical axis O (Z axis). Therefore, the driving mechanism 400 can perform the functions of Auto-Focusing (AF) and Optical Image Stabilization (OIS).

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A driving mechanism for moving an optical element, comprising:
a fixed part;
a movable part, movably connected to the fixed part for holding the optical element; and
a driving assembly, configured for moving the optical element relative to the fixed part.

2. The driving mechanism as claimed in claim 1, further comprising a substrate, wherein the fixed part includes a shield, and the movable part includes a resilient circuit board, wherein at least a part of the circuit board is located between the substrate and the shield.

3. The driving mechanism as claimed in claim 2, wherein the substrate forms a recess, and the circuit board has a conductive terminal portion received in the recess.

4. The driving mechanism as claimed in claim 3, wherein when viewed along a horizontal direction perpendicular to an optical axis of the optical element, the conductive terminal portion and the substrate at least partially overlap.

5. The driving mechanism as claimed in claim 4, wherein a lower surface of the conductive terminal portion is aligned with a bottom surface of the substrate.

6. The driving mechanism as claimed in claim 4, wherein the optical element comprises an image sensor.

7. The driving mechanism as claimed in claim 2, wherein the circuit board is covered by the substrate.

8. The driving mechanism as claimed in claim 2, wherein the circuit board is electrically connected to the substrate.

9. The driving mechanism as claimed in claim 2, wherein the hardness of the substrate is greater than the hardness of the circuit board.

10. The driving mechanism as claimed in claim 2, further comprising a first module, a second module, and a third module connected to each other, wherein the first module has the shield, the circuit board, the driving assembly, a first housing connected to the shield, and a first optical lens disposed in the first housing, the second module has a second housing and a second optical lens disposed in the second housing, and the third module has the substrate, a third housing, and a third optical lens disposed on the third housing, wherein the substrate is affixed to the bottom of the third housing.

11. The driving mechanism as claimed in claim 10, wherein the second module is located between the first and third modules, the first and third optical lenses are prisms, the second optical lens comprises a transparent lens, and the optical element comprises an image sensor.

12. The driving mechanism as claimed in claim 10, wherein the first module further has a first frame and a second frame disposed on the circuit board, the second frame is located between the first frame and the shield, and the driving assembly includes a first coil disposed on the first frame and a first magnet disposed on the second frame.

13. The driving mechanism as claimed in claim 12, wherein the driving assembly further includes a second coil disposed on the second frame and a second magnet disposed on the shield.

14. The driving mechanism as claimed in claim 13, wherein the shield, the first frame, and the second frame respectively have a C-shaped structure facing the same direction.

15. The driving mechanism as claimed in claim 12, wherein the first coil surrounds the optical axis of the optical element, and the optical axis extends through the first optical lens.

16. The driving mechanism as claimed in claim 10, wherein the first module further has a first frame and a second frame disposed on the circuit board, the second frame is located between the shield and the first frame, and the driving assembly includes a first coil, a second coil, and a common magnet, wherein the first coil is disposed on the first frame, the common magnet is disposed on the second frame, and the second coil is disposed on a lower surface of the first housing, wherein the first and second coils are located close to the common magnet.

17. The driving mechanism as claimed in claim 10, wherein the first module further has a first frame and a second frame disposed on the circuit board, and the circuit board has a first connecting portion, a second connecting portion, and a first resilient structure, wherein the first frame is disposed on the first connecting portion, the second frame is disposed on the second connecting portion, and the first resilient structure is connected between the first and second connecting portions.

18. The driving mechanism as claimed in claim 17, wherein the circuit board further has a third connecting portion and a second resilient structure, and the second resilient structure is connected between the second and third connecting portions.

19. The driving mechanism as claimed in claim 17, wherein the shield is affixed to the substrate.

20. The driving mechanism as claimed in claim 10, wherein the circuit board has an extending portion that extends across the second module to the third module.

21. The driving mechanism as claimed in claim 20, wherein the extending portion forms a through hole for receiving a part of the driving assembly.

22. The driving mechanism as claimed in claim 21, wherein the extending portion has a C-shaped structure and is parallel to an optical axis of the optical element.

23. The driving mechanism as claimed in claim 1, wherein the fixed part includes a shield, the movable part includes a resilient circuit board, and the driving mechanism further comprises a first frame and a second frame disposed on the circuit board, wherein the driving assembly is disposed on the shield, the first frame, and the second frame, and the second frame is located between the first frame and the shield.
